(19) United States
(12) Patent Application Publication
(10) Pub. No.: US 2007/0234998 A1
(43) Pub. Date: Oct. 11, 2007

(54) Shut-down device for engine of portable working machine

(75) Inventors: Yuusuke Kinoshita, Tokyo (JP); Naoki Tsuda, Tokyo (JP); Masaki Takeda, Tokyo (JP)

Correspondence Address: BAKER BOTTS L.L.P., 30 ROCKEFELLER PLAZA, 44TH FLOOR, NEW YORK, NY, 10112-4498, US

(73) Assignee: Kioritz Corporation, Tokyo (JP)

(21) Appl. No.: 11/732,799

(22) Filed: Apr. 4, 2007

(30) Foreign Application Priority Data
Apr. 6, 2006 (JP) 2006-105360

(51) Int. Cl. F02M 17/30; F02D 17/00; F02B 77/08

(52) U.S. Cl. 123/198 D

(57) ABSTRACT

An engine shut-down device, which protects a portable working machine from static electricity discharge damage, is provided. In the portable working machine, engine operation can be stopped by switching or forcing a short-circuit at a primary coil in the ignition unit of the engine. The engine shut-down device, includes a manually operable ON/OFF switch for switching or forcing the short-circuit, and an conductive ground-mounting plate that is interposed between a switch operating member and a main switch body. The ground-mounting plate is electrically grounded at a designated electric grounding portion of the engine. Static electricity accumulated in the working machine can discharge via a path running directly from the ground-mounting plate to ground avoiding harmful passage through the ignition unit.

### BACKGROUND OF THE INVENTION

The present invention relates to a portable working machine, which includes a fan, an engine for driving and rotating the fan, and an ignition unit for effecting spark-ignition of the engine by means of an ignition plug. The invention, in particular, relates to an engine shut-down device, which can stop the operation of the engine by a short-circuit at the primary coil of the ignition coil of the ignition unit.

A portable working machine that uses an internal combustion engine as a power source (e.g., an small air-cooled two-stroke gasoline engine), is generally equipped with an engine shut-down device, which can stop the operation of the engine by a short-circuit (or by grounding) of the primary coil of the ignition coil. This engine shut-down device is generally provided with a convenient shutdown switch, which is attached to a holding handle of the portable working machine. The shutdown switch can be conveniently finger-operated by an operator. When it is desired to stop or suspend machine operation, the shutdown switch can be turned ON to effect the short-circuit at the primary coil of the ignition coil. This forces the voltage generated at the secondary coil of the ignition coil to become 0V, thus stopping the spark-ignition at the ignition plug. The shutdown switch, usually includes a main switch body having a pair of contact points (terminals), and a sliding knob, which is designed to be operated by the operator's fingers so as to turn the shutdown switch ON or OFF, and a faceplate made of a conductive metal that is interposed between the sliding knob and the main switch body.

Incidentally, since the shutdown switch is designed to be operated by the operator's fingers, for electrical safety one of the contact points (terminals) of the shutdown switch is usually connected to earth (ground), and only the other contact point is connected with the ignition unit (i.e. an inner circuit thereof). In the case of portable working machines, several conventional grounding systems have been employed or proposed in order to prevent the operator's body from receiving an electric shock due to static electricity or current leakage. (See e.g., JP Utility Model Publication (Kokoku) No. 53-25912Y (1978)).

The is noted that in the case of a portable scavenging working machine (e.g., a leaf blower or vacuum, which is used for blowing away or sucking in fallen leaves, refuse, etc.) plastic materials are commonly used for fabricating the fan, outer casings, and other components of the machine. These fabrication materials allow a large quantity of static electricity to accumulate on components made of such materials and the engine, and particularly so when the portable working machine is operated under dry conditions (e.g., in winter). The accumulated static electricity can discharge passing through the engine (e.g., via the ignition coil (CDI coil) core, the inner circuit of ignition unit, the terminals of shutdown switch (faceplate), and the operator's body (fingers)) to ground, and thereby damage to the inner circuit (diode, etc.) of ignition unit.

The discharge accumulated static electricity to ground may occur when the operator's hand or finger inadvertently contacts the sliding knob of shutdown switch during the operation of the working machine, or at the moment when the operator's hand or finger contacts the sliding knob of shutdown switch when the operator advertently tries to stop the engine. The discharge of this accumulated static electricity to ground (e.g. when the operator tries to stop the engine), can occur within a very short period of time immediately before the switch state in which the static electricity is properly or safely permitted to pass to the earth or grounding contact point after the closure of the contact points. Previously, attention has not been paid to this manner of static electricity discharge as a cause for the damage of the ignition unit.

Further, consideration is now being given to operator and portable working machine safety. In particular, attention is being directed to improving portable working machine designs to prevent damage or injury resulting from improper discharge of accumulated static electricity. A desirable portable working machine will have an engine shut-down device, which is capable of reliably and safely discharging accumulated static electricity, which may have accumulated on the engine or plastic material components, without permitting the discharge to pass through the inner circuit of ignition unit, thereby preventing damage to the inner circuit of ignition unit.

### SUMMARY OF THE INVENTION

The present invention provides an engine shut-down device for a portable working machine, which includes an ignition unit. The engine shut-down device is designed to prevent damage to the inner circuit of ignition unit, which can be caused by discharge of static electricity accumulated on machine components to ground through the ignition unit.

An exemplary portable working machine includes a fan, an engine for rotatively driving the fan, an ignition unit for generating spark-ignition at an engine ignition plug, and the inventive engine shutdown device. Engine operation can be suspended by effecting a short-circuit at the primary coil of ignition coil of the ignition unit using the engine shut-down device. The inventive engine shutdown device includes a switch main body having a pair of contact points, an operating member that can be operated by an operator's fingers to turn the switch ON or OFF, a ground-mounting plate made of a conductive metal interposed between the operating member and the main switch body, and a lead wire for electrically connecting the ground-mounting plate with an electric grounding portion assigned to the engine.

In a preferred embodiment of the engine shutdown device, a faceplate made of a conductive metal, which is in contact at all the times with the ground-mounting plate, is interposed between the operating member and the ground-mounting plate.

The ground-mounting plate is electrically connected by the lead wire to a cylinder cover, which may be the electric grounding portion assigned to the engine.

In a further preferred embodiment of the engine shutdown device, the entire ground-mounting plate or a portion thereof is curved to form a curved portion to which the faceplate is elastically press-contacted.

In a further preferred embodiment of the engine shutdown device, a sliding member for opening or closing the pair of the contact points is mounted on the switch main body on which the ground-mounting plate is mounted. A sliding knob, which acts as the operating member, is disposed on the faceplate, which is placed on the curved portion of the ground-mounting plate. The sliding knob and the faceplate are suitably clamped to and pressed against the curved portion of the ground-mounting plate. A bolt or similar means, which can be screw-engaged with the sliding member, may be used for clamping the components together.

In the inventive engine shut-down device for a portable working machine, the ground-mounting plate is at all times in physical contact with the faceplate and is directly connected by the lead wire to an electric grounding portion of the engine (e.g., a cylinder cover). This configuration of components provides an electrical path for the discharge of even high levels of static electricity, which may accumulate on plastic material portions or other portions of the portable working machine to discharge to ground without passing through the inner circuit of ignition unit. This particular configuration reliably prevents the discharge or electric current from trespassing of into the inner circuit of ignition unit. Thus, the configuration effectively prevents static electricity from damaging the inner circuit of ignition unit that may be caused by the static electricity.

### BRIEF DESCRIPTION OF THE SEVERAL VIEWS OF THE DRAWING

Further features of the invention, its nature, and various advantages will be more apparent from the following detailed description and the accompanying drawings.

FIG. 1 is a perspective view illustrating an exemplary portable working machine provided with an engine shut-down device, in accordance with the principles of the present invention;

FIG. 2 is an enlarged perspective view of a main portion of the portable working machine shown in FIG. 1;

FIGS. 3A, 3B and 3D illustrations of a ground-mounting plate used in the engine shut-down device of FIG. 1, in accordance with the principles of the present invention. FIGS. 3A, 3B and 3D respectively show a cross-sectional, a plan view and a perspective view of the ground-mounting plate.

FIG. 3C is an illustration of a lead wire, which is attached to the ground-mounting plate (FIG. 3D), in accordance with the principles of the present invention;

FIGS. 4A and 4B are schematic illustrations of an assembly of a switch main body, a ground-mounting plate, a faceplate, a sliding knob and a bolt), in accordance with the principles of the present invention. FIGS. 4A and 4B respectively show cross sectional views of the switch components in exploded and assembled state.

FIGS. 5(A)-(C) are plan view illustrations of switch body assembly including a switch main body, a ground-mounting plate, a faceplate, a sliding knob and a bolt, in accordance with the principles of the present invention.

FIG. 6 is an illustration of a main portion of the portable working machine shown in FIG. 2. FIG. 6 shows a persecutive view of the machine with its rear case removed.

FIG. 7 is a schematic diagram, which illustrates the safe discharge of static electricity by the engine shut-down device bypassing the ignition unit, in accordance with the principles of the present invention.

Throughout the figures the same reference numerals and characters, unless otherwise stated, are used to denote like features, elements, components or portions of the illustrated embodiments. Moreover, while the present invention will now be described in detail with reference to the figures, it is done so in connection with the illustrative embodiments.

### DETAILED DESCRIPTION OF THE INVENTION

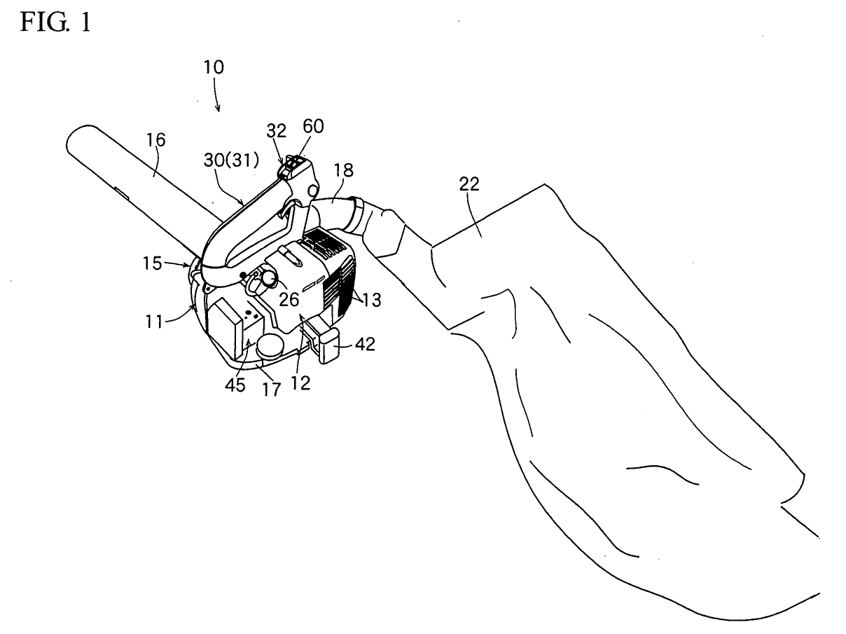

FIG. 1 shows an exemplary portable working machine 10, which is provided with an engine shut-down device 32 capable of safely discharging static electricity in accordance with the principles of the present invention.

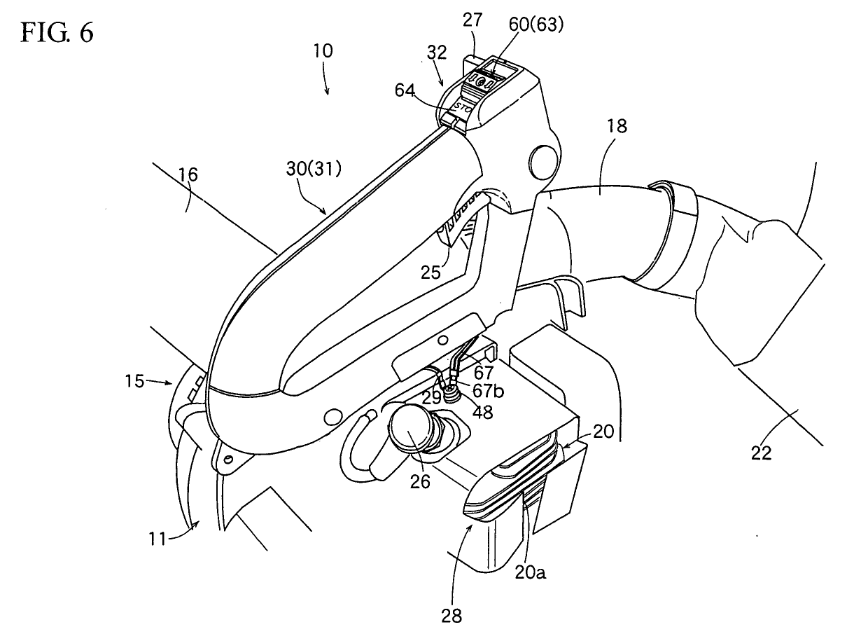

Exemplary portable working machine 10 may be a hand-held leaf blower and/or vacuuming machine, which is designed to clear fallen leaves and other debris (e.g., in gardens or roadway cleaning use). Portable working machine 10 may include a centrifugal fan 15 disposed inside a fore-casing 11, and an small air-cooled two-stroke gasoline engine 20 (FIG. 6) diposed in a rear-casing 12. Rear-casing 12 may have a large number of slits 13 for air ventilation, and a fuel tank 17 at the bottom of machine 10 to hold fuel for operation of engine 20. Engine 20 rotatably drives centrifugal fan 15, which generates the air stream for blowing or sucking in fallen leaves, etc.

An inlet port (not shown) is disposed on the front of fore-casing 11, and a suction pipe 16 is attached to this inlet port to communicate the air stream generated by centrifugal fan 15 herewith. Similarly, a discharge port 18 is disposed on fore-casing 11 containing the centrifugal fan 15. An air-permeable collecting bag 22 for collecting fallen leaves or other debris sucked in by the air stream may be attached to discharge port 18

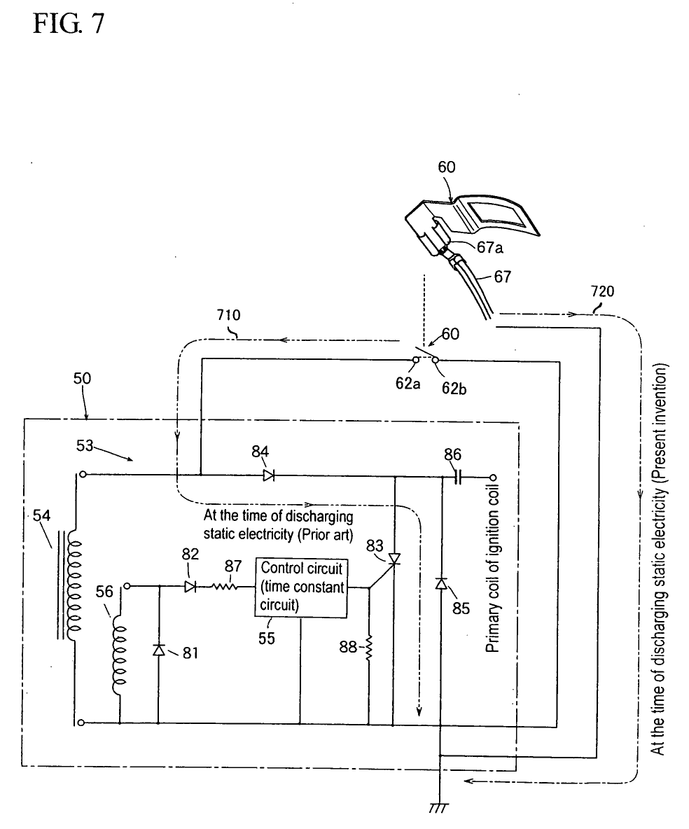

An electric control device 45 having an ignition unit 50 (FIG. 7) is disposed inside rear-casing 12 or in the vicinity thereof. Ignition unit 50 includes an ignition plug 26 to provide spark-ignition for engine operation.

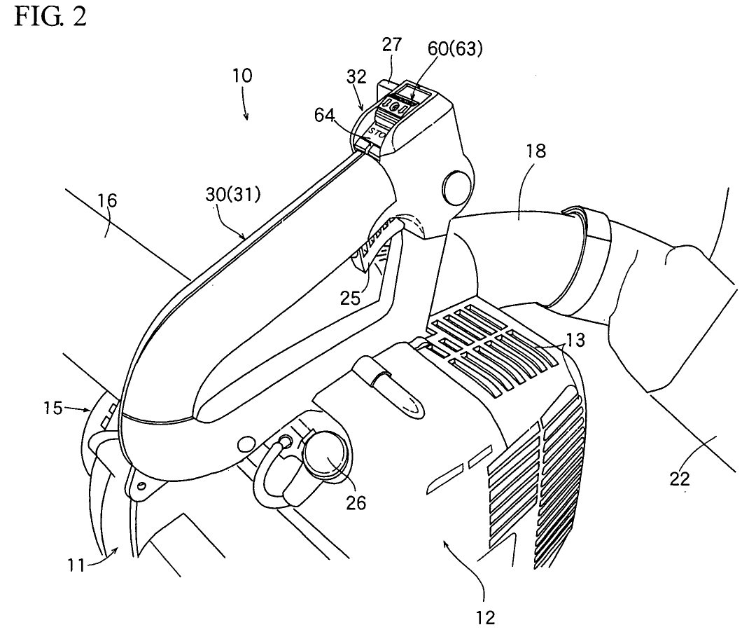

A main handle 30 and a rear handle 42 are provided for hand-held operation of the portable working machine 10. Main handle 30, which may have a two-part structure, is mounted at an upper joint portion between the fore-casing 11 and the rear-casing 12, and rear handle 42 is attached to a lower portion of the rear-casing 12. FIG. 2, which is an enlarged view of portions portable working machine 10, shows further details of the configuration of main handle 30. Main handle 30 includes a grip portion 31, which can be held by an operator, and a mechanical case portion 32, which is disposed at a distal end of grip portion 31. A throttle lever 25, which actuates machine operation, is attached to the underside of the distal portion of grip portion 31. A lock lever 27, which, for example, is attached to the front face of the mechanical case portion 32, may be used to lock or unlock operation of throttle lever 25.

The inventive engine shut-down device for stopping the operation of the engine 20 is suitably disposed, for example, in mechanical case portion 32. The engine shut-down device includes a manually operable shutdown switch 60 that is disposed on a top surface of mechanical case portion 32. As previously noted, the engine shut-down device is designed to stop operation of engine 20 by implementing a short-circuit at the primary coil of the ignition coil of the ignition unit 50.

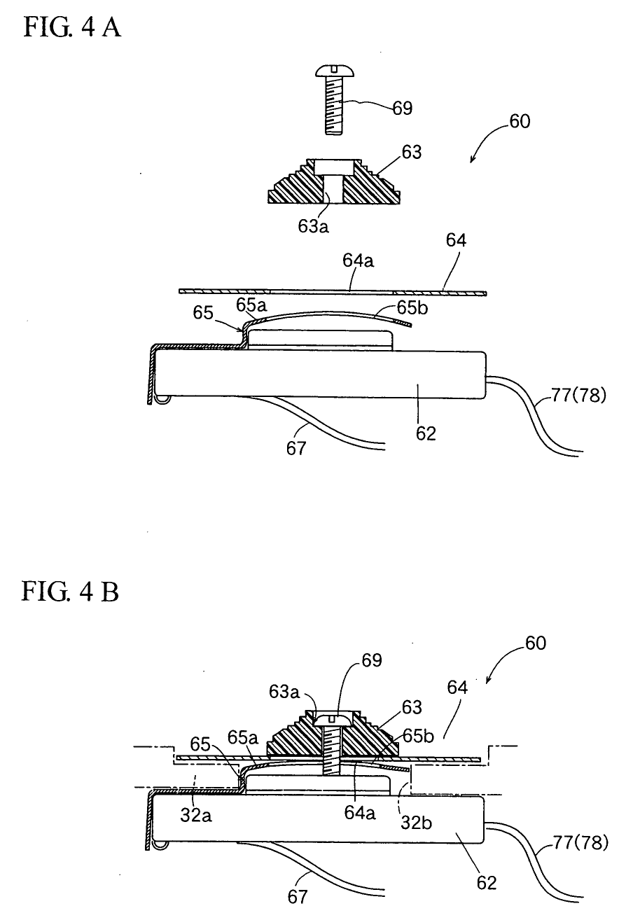

FIGS. 4-7 show further details of the construction of shutdown switch 60. Exemplary shutdown switch 60 includes a switch main body 62 having a pair of contact points or terminals 62a, 62b (FIG. 7), a sliding member 68 for opening or closing contact points 62a and 62b, and a coupled operating member (e.g., sliding knob 63) that is designed to be manually operated between ON and OFF positions (e.g., by a machine operator using his or her fingers.)

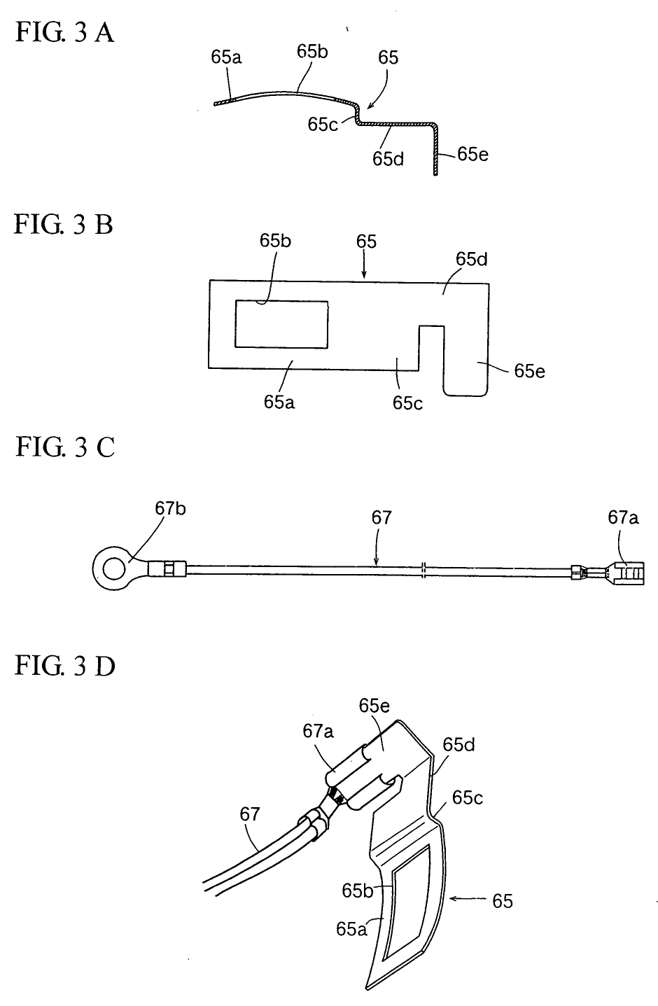

Shutdown switch 60 also includes a faceplate 64, and a ground-mounting plate 65. (See e.g., FIGS. 4A and 4B). Faceplate 64 is made of a conductive material (e.g., an aluminum alloy). Faceplate 64, which may have a rectangular plate-like configuration with a rectangular window 64a, is interposed between the sliding knob 63 and switch main body 62. Ground-mounting plate 65, which is also made of a conductive metal (e.g. phosphor bronze), is positioned to be physical contact at all times with faceplate 64 in assembled switch 60. (See e.g., FIG. 4B). A lead wire 67, which is shown for example, in FIG. 3C, electrically connects ground-mounting plate 65 to an assigned electric grounding portion or grounding cable (e.g., a cylinder cover 23) of the engine.

FIGS. 3(A), 3B and 3D respectively show a cross-sectional view, a plan view, and a perspective view of an exemplary ground-mounting plate 65. Ground-mounting plate 65, which may be fabricated from suitable sheet material, includes a rectangular plate portion 65a having a rectangular cutout or window 65b, and other plate portions 65c, 65d and 65e. The sheet material is shaped so that a rectangular plate portion 65a is curved upward (e.g., to the left in FIG. 3D) to form a convex-shaped portion. Plate portion 65e may be shaped to serve as a tab for connecting lead wire 67. Plate portion 65e and other intermediate plate portions 65c, 65d are shaped successively and contiguously to the convex-shaped portion 65a so that plate portion 65e is in a geometrically suitable position for attaching lead wire 67.

One end of lead wire 67 is attached to plate portion 65e using any suitable means including, for example, a press-fitting connector 67a having nipping wall portions (FIGS. 3C and 3D). The attached lead wire 67 passes through main handle 30/mechanical case portion 32 and so that the other end portion of lead wire 67 extends through the bottom of mechanical case portion 32. (See FIG. 6). Any suitable means may be used to connect or clamp the other end portion of lead wire 67 together with earth cable 29 of the cylinder cover 28. FIG. 6 shows, for example, lead wire 67 with a ring-end connector 67b (FIG. 3C), which is connected to with earth cable 29 of the cylinder cover 28 by means of a clamping screw member 48.

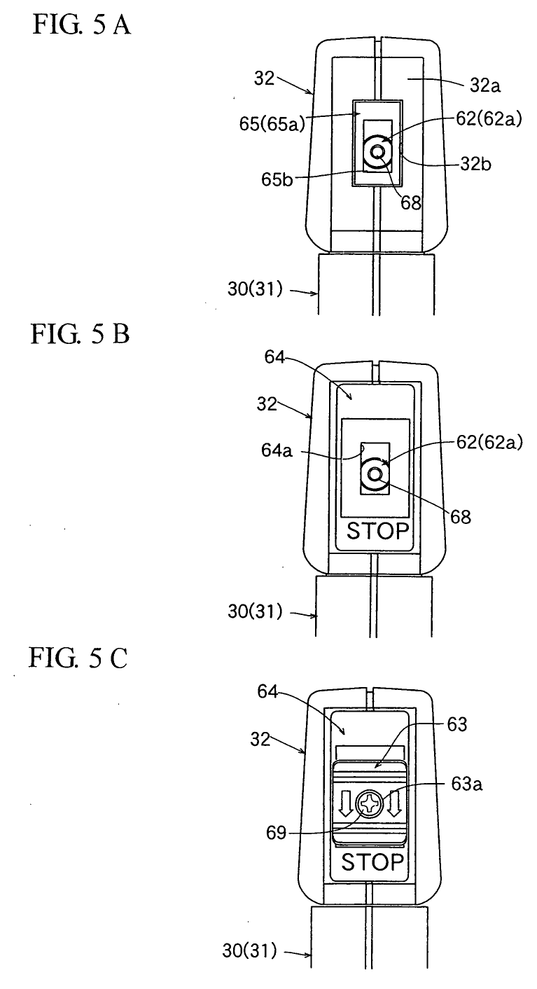

As previously noted switch main body 62 is provided with a sliding member 68 for opening or closing contact points 62a and 62b. FIGS. 4A, 4B and 5A-5C show the relative dispositions of ground-mounting plate 65, faceplate 64, and sliding knob 63, which is coupled to sliding member 68. As seen in the FIGS., ground-mounting plate 65 is disposed on the switch main body 62, and, at the same time, faceplate 64 is placed on the surface of the curved plate portion 65a of ground-mounting plate 65. Further, sliding member 68 and sliding knob 63 are arranged so that sliding knob 63 extends through or above faceplate 64. Sliding knob 63 and faceplate 64 are clamped together, and faceplate 64 is pressed against curved plate portion 65a of ground-mounting plate 65. Any suitable means may be used of this purpose. For example, a bolt 69 which is adapted to be screw-engaged with sliding member 62 may be used to clamp sliding knob 63 and faceplate 64, and press faceplate 64 against curved plate portion 65a. This mechanical or geometrical arrangement design ensures that curved plate portion 65a of ground-mounting plate 65 is always elastically press-contacted with faceplate 64. Further, the mechanical or geometrical arrangement prevents curved plate portion 65a from losing contact with faceplate 64 even as sliding knob 63 is caused to slide (e.g., on the occasion of turning the switch 60 ON or OFF).

With renewed reference to FIG. 4b, it is noted that mechanical case portion 32 may be configured to have a mounting plane 32a with a rectangular opening 32b for mounting switch 60 on portable working machine 10. As shown in FIGS. 4B and 5A-C, ground-mounting plate 65 is configured so that curved plate portion 65a can protrude out of or upward through rectangular opening 32b. Further, to mount switch 60, faceplate 64 is placed on curved plate portion 65a as well as on mounting plane 32a. Bolt 69, which extends across rectangular window 64a of faceplate 64 and across rectangular window 65b of the ground-mounting plate 65, is screw-engaged with a female thread 68 of sliding member 62 through a stepped hole 63a in sliding knob 63.

The electrical operation of switch 60 and the superior safety features provided by switch 60 can be understood with reference to FIG. 7. Ignition unit 50, which may be identical to or similar to a conventional ignition unit, includes an inner circuit 53 and ignition coils (i.e., primary and secondary coils) (not shown). Inner circuit 53 includes a generator 54 (e.g., consisting of a magnet, which is built in an air cooling fan-attached rotor attached to one end portion of the crankshaft of engine 20), a control circuit (time-constant circuit) 55, a trigger coil 56, diodes 81, 82, 83, 84 and 85, a capacitor 86, and resistors 87 and 88.

According to the present invention, shutdown switch 60 is built on this inner circuit 53. In conventional working machines with prior art engine shut-down devices that are not provided with switch 60 or similar switch structure described herein, accumulated static electricity will be discharge through a path passing through inner circuit 53 of the ignition unit 50 (e.g., path 710). In contrast, provision of switch 60 with inner circuit 53, provides an alternate path (e.g., path 720) for static electricity discharge, which does not pass through inner circuit 53. As described above ground-mounting plate 65 is in contact at all the times with the faceplate 64 and, at the same time, is directly grounded by lead wire 67 with an engine electric grounding portion (e.g. cylinder cover 28). Any static electricity accumulated at the engine or elsewhere in the working machine is preliminarily discharged through ground-mounting plate 65 to ground (e.g., on the occasion of discharging the static electricity through the contact between working machine and operator body or fingers)). Even large accumulations of static electricity can be safely and reliably discharged through path 720, without permitting the static electricity to pass to the inner circuit of ignition unit. As a result, switch 60 can effectively prevent damage to inner circuit 53 (e.g., diode 85, etc.) of ignition unit 50 that may be caused by the static electricity.

1. An engine shut-down device for a portable working machine having a fan, an engine for rotatively driving the fan, and an ignition unit for generating spark-ignition at an ignition plug at the engine,
wherein suspension of engine operation is effected by switching in a short-circuit at the primary coil of ignition coil of the ignition unit,
the engine shut-down device comprising:
a switch having a main body and a pair of contact points;
an operating member that is manually operable to open or close the contact points so as to turn the switch on or off; and
a conductive ground-mounting plate interposed between the operating member and the main switch body; wherein the ground-mounting plate is electrically grounded at an electric grounding portion of the engine.

2. The engine shut-down device according to claim 1, wherein a conductive faceplate is interposed between the operating member and the ground-mounting plate, so that the face plate and the ground-mounting plate are in physical contact in all switch positions.

3. The engine shut-down device according to claim 1 wherein the ground-mounting plate is electrically connected by a lead wire to a cylinder cover of the engine, wherein the cylinder cover is an electric grounding portion assigned to the engine.

4. The engine shut-down device according to claim 2, wherein the ground-mounting plate is shaped to form a curved portion with which the faceplate is elastically press-contacted.

5. The engine shut-down device according to claim 4, wherein a sliding member for opening or closing the pair of the contact points is mounted on the switch main body, the ground-mounting plate is mounted on the switch main body, the faceplate is placed on a portion of the ground-mounting plate, a sliding knob acting as the operating member is disposed on the faceplate, and the sliding knob and the faceplate are clamped together and attached to the sliding member, and the faceplate is pressed against the portion of the ground-mounting plate against which it is placed.

6. A method for providing a path for accumulated static electricity discharge in a portable working machine having a fan, an engine for rotatively driving the fan, and an ignition unit for generating spark-ignition at an ignition plug at the engine; wherein suspension of engine operation is effected by switching in a short-circuit at the primary coil of ignition coil of the ignition unit,
the method comprising providing an engine shut-down device including:
a switch having a main body and a pair of contact points;
an operating member that is manually operable to open or close the contact points so as to turn the switch on or off; and
a conductive ground-mounting plate interposed between the operating member and the main switch body; wherein the ground-mounting plate is electrically grounded at an electric grounding portion of the engine,
whereby static electricity accumulated in or on the working machine is provided with a discharge path extending directly from the ground-mounting plate to ground avoiding passage through the ignition unit.
